(19) United States
(12) Patent Application Publication
(10) Pub. No.: US 2007/0072789 A1
(43) Pub. Date: Mar. 29, 2007

(54) 2-Methyl-5-phenylpentanal used as a rose odoriferous substance

(75) Inventors: Walter Kuhn, Holzminden (DE); Lutz Walther, Holzminden (DE); Horst Surburg, Holzminden (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: SYMRISE GMBH & CO. KG, Holzminden (DE)

(21) Appl. No.: 10/558,287

(22) PCT Filed: May 17, 2004
(86) PCT No.: PCT/EP04/50822

§ 371 Date: Aug. 21, 2006

(30) Foreign Application Priority Data
May 27, 2003 (DE) 103 24 018.7
Jun. 6, 2003 (DE) 103 25 628.8

(51) Int. Cl. A61Q 13/00

(52) U.S. Cl. 512/1

(57) ABSTRACT

The use of 2-methyl-5-phenyl pentanal is described for producing, modifying or intensifying a rose scent.

The present invention concerns the use of 2-methyl-5-phenyl pentanal as a rose fragrance substance, i.e. as an agent for producing, modifying or intensifying a rose scent. Further aspects of the invention follow from the description below and the claims.

In view of the growing demand by consumers for new, modern perfume notes, which correspond to an up-to-date, modern attitude to life, there exists in the perfume industry a strong need for scents with which novel effects can be obtained in perfumes, thereby creating new fashion trends.

Floral notes (flower notes) have a central importance in perfume composition. They form the so-called “heart note” of a perfume and substantially influence the fragrance type. The most important floral notes used in the perfume industry are lily of the valley, rose and jasmine scents. Lily of the valley scent gives perfumes freshness and cleanliness, rose scent imparts elegance and femininity, and heavy, exotically sensuous fragrance complexes are created by the use of jasmine scent.

By reason of their fragrance character, rose notes are extremely important for the composition of perfumes, particularly those which are used for the direct application of perfume to the skin, such as e.g. in alcoholic lotions and in cosmetic preparations such as skin creams.

Classical rose fragrance substances, which are used in large quantities in the production of perfumes, are geraniol, citronellol and phenylethyl alcohol, for example. These compounds also occur as principal components in natural extracts obtained from rose petals. They are therefore suitable above all for imitating the natural scent of roses.

These substances are only of very limited use, however, for the creation of novel, modern, original compositions which are intended to break away from the character of the naturally occurring rose scent. There is therefore a need for fragrance substances with a rose-like character which because of their olfactory properties are suitable for use as a basis for the composition of novel modern perfumes having a rose note.

Surprisingly it has now been found that the compound 2-methyl-5-phenyl pentanal has a rose scent which corresponds to the profile of requirements outlined above. In perfumistic tests, 2-methyl-5-phenyl pentanal was found to be a fragrance substance having a sweetly floral, very complex rose scent and a light waxy green note. 2-Methyl-5-phenyl pentanal is therefore outstandingly suitable for the development of perfumes with novel abstract original fragrances having a rose note.

The above perfumistic assessment of 2-methyl-5-phenyl pentanal is surprising, since this compound has already been mentioned twice in the literature in connection with the provision of new fragrance substances, without any mention being made of the rose scent which is of particular perfumistic interest. Our own research has now shown that the references in the literature to the sensorial assessment of 2-methyl-5-phenyl pentanal are incorrect, possibly because in both cases the focus of the research upon which the publications were based was not 2-methyl-5-phenyl pentanal.

Thus an olfactory description is given for 2-methyl-5-phenyl pentanal in U.S. Pat. No. 6,310,033 B1, but the description “soft, green, fatty ozone” is incomplete at least, if not completely wrong.

However, the focus of U.S. Pat. No. 6,310,033 B1 clearly lies on 2,4-dimethyl derivatives (see the claims of U.S. Pat. No. 6,310,033 B1), which possibly explains the false assessment with regard to 2-methyl-5-phenyl pentanal.

It should be mentioned in addition that the substance 2-methyl-5-phenyl pentanol, which structurally is naturally very closely related to the compound 2-methyl-5-phenyl pentanal, is a fragrance substance having a rose-like character which corresponds to the general olfactory description in U.S. Pat. No. 6,310,033 B1. In that respect the statements made in U.S. Pat. No. 6,310,033 B1 are therefore confirmed. The olfactory properties of 2-methyl-5-phenyl pentanol tend towards the classical rose fragrance substances mentioned at the start; it is therefore mainly used for classical rose compositions having a lasting effect. In comparison to the corresponding alcohol, 2-methyl-5-phenyl pentanal has a substantially greater intensity, emanation and elegance and is therefore particularly suitable for use in new modern original rose notes.

3-Methyl-5-phenyl pentanal, which structurally is likewise very similar to the compound 2-methyl-5-phenyl pentanal, has a scent profile which tends very strongly towards citrus-like freshness. In that respect too the general olfactory assessment from U.S. Pat. No. 6,310,033 B1 is therefore confirmed.

It is therefore all the more surprising that the assessment given in U.S. Pat. No. 6,310,033 B1 with regard to 2-methyl-5-phenyl pentanal is not correct.

DE-OS 2 051 319 describes substituted alkanals having a general formula 1, and it is stated in global terms that these have a “fresh, floral scent”. The substance 2-methyl-5-phenyl pentanal which comes under formula I is disclosed as a constituent of a mixture which also includes 2-ethyl-4-phenyl butanal (1-phenyl-3-formyl pentane). DE-OS 2 051 319 does not however provide an olfactory description relating to this mixture or even an olfactory description of 2-methyl-5-phenyl pentanal itself. The term “floral” applied wholesale to all alkanals having formula I can be interpreted only as an indication of a very general olfactory trend. As already mentioned, floral fragrance substances having very different olfactory properties are used in the perfume industry in correspondingly different areas. In view of the large number of scent variants which come under this term, the comment “floral” is not helpful in a systematic search for compounds having a rose scent.

2-Methyl-5-phenyl pentanal is particularly suitable for modifying the rose scent of a fragrance composition comprising at least one further fragrance substance having a rose scent. Particularly sophisticated, modern perfume compositions can be created in this way.

2-Methyl-5-phenyl pentanal is advantageously used for the preparation of a perfume having a rose scent; a corresponding process comprises the following steps:
Preparation of 2-methyl-5-phenyl pentanal,
Preparation of conventional perfume constituents and
Production of a mixture of the conventional perfume constituents with an adequate (sensorially effective) amount of 2-methyl-5-phenyl pentanal, such that the resulting perfume has a rose scent which is brought about or influenced by the presence of 2-methyl-5-phenyl pentanal.

The rose scent of the perfume is brought about by 2-methyl-5-phenyl pentanal if none of the other conventional perfume constituents present has a rose scent itself. If other perfume constituents having a rose scent are present, the 2-methyl-5-phenyl pentanal contributes to the overall rose scent which is imparted and thus influences it.

A process according to the invention for producing, intensifying or modifying a rose scent of a mixture comprises the following steps:
Preparation of 2-methyl-5-phenyl pentanal,
Preparation of a composition comprising other constituents and
- Mixing the composition comprising other constituents with an amount of 2-methyl-5-phenyl pentanal which is sufficient (a) to bring about a rose scent in the resulting overall mixture, (b) to intensify an existing rose scent in the composition comprising other constituents or (c) to modify an existing rose scent in the composition comprising other constituents.

The other constituents can themselves be perfume constituents, but constituents which are not conventionally found in a perfume can also be present in the mixture.

Examples of other conventional perfume constituents with which 2-methyl-5-phenyl pentanal can advantageously be combined can be found for example in S. Arctander, Perfume and Flavor Materials, Vol. I and II, Montclair, N. J., 1969, self-published or K. Bauer, D. Garbe and H. Surburg, Common Fragrance and Flavor Materials, 4^{th} Ed., Wiley-VCH, Weinheim 2001.

The following specific examples can be cited:

Extracts of natural raw materials such as essential oils, concretes, absolutes, resins, resinoids, balsams, tinctures, such as, for example ambergris tincture; amyris oil; angelica seed oil; angelica root oil; aniseed oil; valerian oil; basil oil; treemoss absolute; bay oil; mugwort oil; benzoin resin; bergamot oil; beeswax absolute; birch tar oil; bitter almond oil; savory oil; buchu leaf oil; cabreuva oil; cade oil; calamus oil; camphor oil; cananga oil; cardamom oil; cascarilla oil; cassia oil; cassie absolute; castoreum absolute; cedar leaf oil; cedarwood oil; cistus oil; citronella oil; citrus oil; copaiba balsam; copaiba balsam oil; coriander oil; costus root oil; cumin oil; cypress oil; davana oil; dill weed oil; dill seed oil; eau de brouts absolute; oakmoss absolute; elemi oil; tarragon oil; eucalyptus citriodora oil; eucalyptus oil; fennel oil; spruce needle oil; galbanum oil; galbanum resin; geranium oil; grapefruit oil; guaiac wood oil; gurjun balsam; gurjun balsam oil; helichrysum absolute; helichrysum oil; ginger oil; iris root absolute; iris root oil; jasmine absolute; calamus oil; camomile blue oil; camomile Roman oil; carrot seed oil; cascarilla oil; pine needle oil; spearmint oil; caraway oil; labdanum oil; labdanum absolute; labdanum resin; lavandin absolute; lavandin oil; lavender absolute; lavender oil; lemongrass oil; lovage oil; distilled lime oil; pressed lime oil; linaloe oil; litsea cubeba oil; bayleaf oil; mace oil; marjoram oil; mandarin oil; massoi bark oil; mimosa absolute; musk seed oil; musk tincture; clary sage oil; nutmeg oil; myrrh absolute; myrrh oil; myrtle oil; clove leaf oil; clove flower oil; neroli oil; olibanum absolute; olibanum oil; opopanax oil; orange flower absolute; orange oil; origanum oil; palmarosa oil; patchouli oil; perilla oil; Peru balsam oil; parsley leaf oil; parsley seed oil; petitgrain oil; peppermint oil; pepper oil; pimento oil; pine oil; pennyroyal oil; rose absolute; rosewood oil; rose oil; rosemary oil; Dalmatian sage oil; Spanish sage oil; sandalwood oil; celery seed oil; spike lavender oil; star anise oil; styrax oil; tagetes oil; fir needle oil; tea-tree oil; turpentine oil; thyme oil; tolu balsam; tonka absolute; tuberose absolute; vanilla extract; violet leaf absolute; verbena oil; vetiver oil; juniper berry oil; cognac oil; wormwood oil; wintergreen oil; ylang-ylang oil; hyssop oil; civet absolute; cinnamon leaf oil; cinnamon bark oil and fractions thereof, or ingredients isolated therefrom;

individual fragrance substances from the group comprising

hydrocarbons, such as, for example, 3-carene; a-pinene; b-pinene; a-terpinene; g-terpinene; p-cymene; bisabolene; camphene; caryophyllene; cedrene; farnesene; limonene; longifolene; myrcene; ocimene; valencene; (E,Z)-1,3,5-undecatriene; styrene; diphenyl methane;

aliphatic alcohols, such as, for example, hexanol; octanol; 3-octanol; 2,6-dimethylheptanol; 2-methyl-2-heptanol; 2-methyl-2-octanol; (E)-2-hexenol; (E)- and (Z)-3-hexenol; 1-octen-3-ol; mixture of 3,4,5,6,6-pentamethyl-3/4-hepten-2-ol and 3,5,6,6-tetramethyl-4-methylene heptan-2-ol; (E,Z)-2,6-nonadienol; 3,7-dimethyl-7-methoxyoctan-2-ol; 9-decenol; 10-undecenol; 4-methyl-3-decen-5-ol;

aliphatic aldehydes and acetals thereof, such as, for example, hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanal diethyl acetal; 1,1-dimethoxy-2,2,5-trimethyl-4-hexene; citronellyl oxyacetaldehyde; 1-(1-methoxypropoxy)-(E/Z)-3-hexene;

aliphatic ketones and oximes thereof, such as, for example, 2-heptanone; 2-octanone; 3-octanone; 2-nonanone; 5-methyl-3-heptanone; 5-methyl-3-heptanone oxime; 2,4,4,7-tetramethyl-6-octen-3-one; 6-methyl-5-hepten-2-one;

aliphatic sulfur-containing compounds, such as, for example, 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol;

aliphatic nitriles, such as, for example, 2-nonenoic acid nitrile; 2-undecenoic acid nitrile; 2-tridecenoic acid nitrile; 3,12-tridecadienoic acid nitrile; 3,7-dimethyl-2,6-octadienoic acid nitrile; 3,7-dimethyl-6-octenoic acid nitrile;

esters of aliphatic carboxylic acids, such as, for example, (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl isobutyrate; hexyl crotonate; ethyl isovalerate; ethyl-2-methylpentanoate; ethyl hexanoate; allyl hexanoate; ethyl heptanoate; allyl heptanoate; ethyl octanoate; ethyl-(E,Z)-2,4-decadienoate; methyl-2-octynoate; methyl-2-nonynoate; allyl-2-isoamyloxyacetate; methyl-3,7-dimethyl-2,6-octadienoate; 4-methyl-2-pentyl crotonate;

acyclic terpene alcohols, such as, for example, citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and formates, acetates, propionates, isobutyrates, butyrates, isovalerates, pentanoates, hexanoates, crotonates, tiglinates and 3-methyl-2-butenoates thereof;

acyclic terpene aldehydes and ketones, such as, for example, geranial; neral; citronellal; 7-hydroxy-3,7-dimethyloctanal; 7-methoxy-3,7-dimethyloctanal; 2,6,10-trimethyl-9-undecenal; geranylacetone; and the dimethyl and diethyl acetals of geranial, neral, 7-hydroxy-3,7-dimethyloctanal;

cyclic terpene alcohols, such as, for example, menthol; isopulegol; alpha-terpineol; terpinenol-4; menthan-8-ol; menthan-1-ol; menthan-7-ol; borneol; isoborneol; linalool oxide; nopol; cedrol; ambrinol; vetiverol; guaiol; and formates, acetates, propionates, isobutyrates, butyrates, isovalerates, pentanoates, hexanoates, crotonates, tiglinates and 3-methyl-2-butenoates thereof;

cyclic terpene aldehydes and ketones, such as, for example, menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; 2-methyl-4-(2,6,6-trimethyl-1-cyclohexen-1-yl)-2-butenal; nootkatone; dihydronootkatone; 4,6,8-megastigmatrien-3-one; alpha-sinensal; beta-sinensal; acetylated cedarwood oil (methyl cedryl ketone);

cyclic alcohols, such as, for example, 4-tert-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;

cycloaliphatic alcohols, such as, for example, alpha-3,3-trimethyl cyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl )-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol;

cyclic and cycloaliphatic ethers, such as, for example, cineol; cedryl methyl ether; cyclododecyl methyl ether; 1,1-dimethoxycyclododecane; (ethoxymethoxy)cyclododecane; alpha-cedrene epoxide; 3a,6,6,9a-tetramethyldodecahydronaphtho[2,1-b]furan; 3a-ethyl-6,6,9a-trimethyidodecahydronaphtho[2,1-b]furan; 1,5,9-trimethyl-13-oxabicyclo[10.1.0]trideca-4,8-diene; rose oxide; 2-(2,4-dimethyl-3-cyclohexen-1-yl)-5-methyl-5-(1-methyl propyl)-1,3-dioxane;

cyclic and macrocyclic ketones, such as, for example, 4-tert-butylcyclohexanone; 2,2,5-trimethyl-5-pentylcyclopentanone; 2-heptylcyclopentanone; 2-pentylcyclopentanone; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert-pentylcyclohexanone; 5-cyclohexadecen-1-one; 6,7-dihydro-1,1,2,3,3-pentamethyl-4(5H)-indanone; 8-cyclohexadecen-1-one; 9-cycloheptadecen-1-one; cyclopentadecanone; cyclohexadecanone;

cycloaliphatic aldehydes, such as, for example, 2,4-dimethyl-3-cyclohexenecarbaldehyde; 2-methyl-4-(2,2,6-trimethylcyclohexen-1-yl)-2-butenal; 4-(4-hydroxy-4-methylpentyl)-3-cyclohexenecarbaldehyde; 4-(4-methyl-3-penten-1-yl )-3-cyclohexenecarbaldehyde; cycloaliphatic ketones, such as, for example, 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl-2,6,10-trimethyl-2,5,9-cyclododecatrienyl ketone; tert-butyl-(2,4-dimethyl-3-cyclohexen-1-yl) ketone;

esters of cyclic alcohols such as, for example, 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentylcyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6-indenyl propionate; 4,7-methano-3a,4,5,6,7,7a-hexahydro-5 or 6-indenyl isobutyrate; 4,7-methanooctahydro-5 or 6-indenyl acetate;

esters of cycloaliphatic alcohols such as, for example, 1-cyclohexylethyl crotonate;

esters of cycloaliphatic carboxylic acids, such as, for example, allyl-3-cyclohexyl propionate; allyl cyclohexyloxyacetate; cis- and trans-methyl dihydrojasmonate; cis- and trans-methyl jasmonate; methyl-2-hexyl-3-oxocyclopentanecarboxylate; ethyl-2-ethyl-6,6-dimethyl-2-cyclohexenecarboxylate; ethyl-2,3,6,6-tetramethyl-2-cyclohexenecarboxylate; ethyl-2-methyl-1,3-dioxolane-2-acetate;

araliphatic alcohols, such as, for example, benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;

esters of araliphatic alcohols and aliphatic carboxylic acids, such as, for example, benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate;

araliphatic ethers, such as, for example, 2-phenylethyl methyl ether; 2-phenylethyl isoamyl ether; 2-phenylethyl-1-ethoxyethyl ether; phenylacetaldehyde dimethyl acetal; phenylacetaldehyde diethyl acetal; hydratropaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;

aromatic and araliphatic aldehydes, such as, for example, benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert-butylphenyl)propanal; 2-methyl-3-(4-isobutylphenyl)propanal; 3-(4-tert-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)propanal;

aromatic and araliphatic ketones, such as, for example, acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)ethanone; 2-benzofuranyl ethanone; (3-methyl-2-benzofuranyl)ethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;

aromatic and araliphatic carboxylic acids and esters thereof, such as, for example, benzoic acid; phenylacetic acid; methyl benzoate; ethyl benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl-2,4-dihydroxy-3,6-dimethylbenzoate; ethyl-3-phenylglycidate; ethyl-3-methyl-3-phenylglycidate;

nitrogen-containing aromatic compounds, such as, for example, 2,4,6-trinitro-1,3-dimethyl-5-tert-butylbenzene; 3,5-dinitro-2,6-dimethyl-4-tert-butylacetophenone; cinnamonitrile; 3-methyl-5-phenyl-2-pentenoic acid nitrile; 3-methyl-5-phenyl pentanoic acid nitrile; methyl anthranilate; methyl-N-methyl anthranilate; Schiff bases of methyl anthranilate with 7-hydroxy-3,7-dimethyloctanal; 2-methyl-3-(4-tert-butylphenyl)propanal or 2,4-dimethyl-3-cyclohexenecarbaldehyde; 6-isopropylquinoline; 6-isobutylquinoline; 6-sec-butylquinoline; 2-(3-phenylpropyl)pyridine; indole; skatole; 2-methoxy-3-isopropylpyrazine; 2-isobutyl-3-methoxypyrazine;

phenols, phenyl ethers and phenyl esters, such as, for example, estragole; anethole; eugenol; eugenyl methyl ether; isoeugenol; isoeugenyl methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate;

heterocyclic compounds, such as, for example, 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;

lactones, such as, for example, 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecanedioate; ethylene-1,13-tridecanedioate; coumarin; 2,3-dihydrocoumarin; octahydrocoumarin.

The invention also concerns personal care products having a rose scent, wherein they can in particular be those selected from the group of products comprising solid and liquid soaps, shower gels, shampoos, shaving soaps, shaving foams, bath additives, cosmetic emulsions of the oil-in-water, water-in-oil and water-in-oil-in-water type, such as e.g. skin creams and lotions, face creams and lotions, sun creams and lotions, aftersun creams and lotions, hand creams and lotions, foot creams and lotions, depilatory creams and lotions, aftershave creams and lotions, tanning creams and lotions, hair care products such as e.g. hair sprays, hair gels, hair setting lotions, hair rinses, permanent and semi-permanent hair colorants, hair sculpting agents such as cold waves and hair smoothing agents, hair waters, hair creams and lotions, perfumed refreshing wipes, deodorants and antiperspirants such as e.g. underarm sprays, roll-ons, deodorant sticks, deodorant creams, and decorative cosmetic products such as e.g. eyeshadows, nail polishes, foundations, lipsticks and mascara. The personal care products according to the invention contain 2-methyl-5-phenyl pentanal and conventional constituents of a personal care product, such as support materials, polishing agents, astringents, moisturising substances, antibacterial agents, anti-acne agents, anticellulite agents, antimicrobial agents, antioxidants, antiperspirants, anti-dandruff agents, antiseptic agents, binders, bleaching agents, chelating agents, creams, deodorising agents, monounsaturated or polyunsaturated fatty acids, emulsifiers, depilatory agents, anti-inflammatory agents, colour-protecting agents, dyes, fats, moisture-retaining substances, moisture creams, moisture-releasing agents, film formers, gel-forming agents, gelling agents, saturated fatty acids, skin lightening agents, skin calming agents, skin tanning agents, skin softening agents, skin healing agents, skin cooling agents, skin conditioning agents, skin cleansing agents, skin protection agents, skin warming agents, irritation inhibiting agents, irritation preventing agents, preservatives, anti-skin ageing agents, surface-active substances, oils, optical brightening agents, conditioning agents, phospholipids, pigments, plasticising agents, polish, polyhydroxy fatty acids, polymers, polyols, proteins, buffers, powders, friction-reducing agents, cleansing agents, nourishing agents, ointments, foaming agents, foam boosters, foam stabilisers, dirt-repelling agents, perspiration inhibiting agents, soaps, silicones, stabilisers, strengthening agents, surfactants, support materials, opacifiers, UV absorbing agents, UV filters, thickening agents, liquefiers, vitamins, waxes, cell stimulants, organic solvents or other conventional constituents of the particular formulation.

The amount of 2-methyl-5-phenyl pentanal in a personal care product according to the invention is calculated such that on the basis of the presence of 2-methyl-5-phenyl pentanal (a) it has a rose scent or (b) it has a modified rose scent in comparison to a composition having said conventional constituents of a personal care product, depending on whether or not one or more of the other constituents of the personal care product themselves have a rose scent.

The invention also concerns fragrance mixtures having a rose scent which contain a sensorially effective amount of 2-methyl-5-phenyl pentanal, sensorially effective amounts of at least two further fragrance substances and optionally other conventional constituents such as solvents or similar. At least one of the other fragrance substances will in many cases have a rose scent, particularly if a fragrance mixture having an extravagant rose scent is sought.

The amount of 2-methyl-5-phenyl pentanal used in the fragrance mixtures according to the invention can be 0.1 to 90 wt. %, a range from 0.5 to 50 wt. % being preferable, and particularly preferably a range from 1 to 25 wt. %, relative to the total mass of the fragrance mixture.

Fragrance mixtures containing 2-methyl-5-phenyl pentanal are advantageously used for perfuming applications in liquid form, undiluted or diluted with a solvent. Suitable solvents for this purpose are, for example, ethanol, isopropanol, diethylene glycol monoethyl ether, glycerol, propylene glycol, 1,2-butylene glycol, dipropylene glycol, diethyl phthalate, triethyl citrate, isopropyl myristate, etc.

Finally the invention also concerns perfumed products comprising a fragrance mixture according to the invention and a carrier or a substrate which is in direct contact with this fragrance mixture. Such perfumed products can be, for example, an alcoholic perfume, a personal care product or a cleaning or conditioning product or similar for use in the home.

Alcoholic perfumes containing a fragrance mixture according to the invention having a rose scent can be chosen for example from the group of products comprising perfume extracts, eau de parfums, eau de toilettes, aftershaves, eau de colognes, preshave products and splash colognes.

Personal care products containing a fragrance mixture according to the invention having a rose scent can be chosen for example from the group of the aforementioned personal care products.

Cleaning or conditioning products for use in the home containing a fragrance mixture according to the invention having a rose scent can be chosen for example from the following group: acid, alkaline and neutral cleaning agents, such as e.g. floor cleaners, window cleaners, washing-up liquids, bath and sanitary cleaners, scouring agent, solid and liquid WC cleaners, powdered and foaming carpet cleaners, fabric refreshers, ironing aids, liquid detergents, powdered detergents, laundry pretreatment agents such as bleaches, soaking agents and stain removers, fabric softeners, laundry soaps, detergent tablets, disinfectants, surface disinfectants and air fresheners in liquid or gel form or applied to a solid support, aerosol sprays, incense sticks, candles, lamp oils, and waxes and polishes such as furniture polishes, floor waxes and shoe creams.

A perfumed product according to the invention is generally produced by adding (a) 2-methyl-5-phenyl pentanal or (b) a fragrance mixture according to the invention (see above), optionally together with other perfume constituents, to the product (to be perfumed), such that on the basis of the presence of 2-methyl-5-phenyl pentanal the resulting perfumed product (a) has a rose scent or (b) in the case of the presence of other perfume constituents having a rose scent has a modified or intensified rose scent.

Fragrance mixtures according to the invention containing 2-methyl-5-phenyl pentanal can be used in concentrated form, in solutions or in the following modified form:

For many applications it is advantageous to use the fragrance mixtures according to the invention adsorbed on a support, which ensures both a fine distribution of the fragrance substances in the product and a controlled release during use. Such supports can be porous inorganic materials such as light sulfate, silica gels, zeolites, gypsums, clays, clay granules, gas concrete, etc., or organic materials such as woods; cellulose-based substances, sugars or plastics such as PVC, polyvinyl acetates or polyurethanes.

For other applications it is advantageous to use the fragrance mixtures according to the invention in microencapsulated or spray-dried form, in the form of an inclusion complex or extrusion product and to add them in this form to the (intermediate) product to be perfumed.

The properties of perfume oils modified in such a way are in many cases further optimised by coating with suitable materials with a view to a more selective fragrance release, waxy plastics such as e.g. polyvinyl alcohol being preferably used.

Microencapsulation of the perfume oils can take place by means of the so-called coacervation process, for example, using capsule materials made from polyurethane-like substances or soft gelatine, for example. The spray-dried perfume oils can be prepared by spray drying an emulsion or dispersion containing the perfume oil, for example, wherein modified starches, proteins, dextrin and vegetable gums can be used as supports. Inclusion complexes can be prepared by, for example, introducing dispersions of the perfume oil and cyclodextrins or urea derivatives into a suitable solvent, e.g. water. Extrusion products can be obtained by melting the perfume oils with a suitable waxy substance and by extrusion and subsequent solidification, optionally in a suitable solvent, e.g. isopropanol.

Finally the invention also concerns a process for producing 2-methyl-5-phenyl pentanal.

Of the production methods to be found in the literature, the methods cited in the aforementioned patent specifications seem to be suitable for a possible technical production if need be:

1. The hydroformylation of 5-phenyl-2-pentene described in DE-OS 2 051 319, which disadvantageously leads not to pure 2-methyl-5-phenyl pentanal but only to mixtures of isomers, however. The disadvantage here is that in order to obtain pure 2-methyl-5-phenyl pentanal, considerable separating work would be necessary, which would lead to high production costs. On the other hand the use of the mixture of isomers in perfumes, fragrance mixtures, personal care products or similar is not practicable, since the 2-ethyl-4-phenyl butanal obtained as a secondary product has a markedly more aggressive inharmonious green note, which interferes with the aesthetic fragrance character of pure 2-methyl-5-phenyl pentanal and thus considerably detracts from its fragrance properties.

2. The aldol reaction of 3-phenyl propanal with propionaldehyde as described in U.S. Pat. No. 6,310,033 B1 and subsequent hydrogenation of the 2-methyl-5-phenyl-2-pentenal that is formed.

By contrast, the process according to the invention comprises the hydrogenation of 2-methyl-5-phenyl-2,4-pentadienal, which can be obtained for example in a manner known per se by condensation of cinnamaldehyde with propionaldehyde. A process for producing 2-methyl-5-phenyl-2,4-pentadienal is described in DE 555490A, for example. If the process according to the invention is used, one reaction step is eliminated and the production is more economical than if 3-phenyl propanal is used as the starting material.

The hydrogenation according to the invention of 2-methyl-5-phenyl-2,4-pentadienal to form 2-methyl-5-phenyl pentanal is advantageously performed with palladium as the hydrogenating catalyst. The palladium can be applied to a support such as activated carbon or aluminium oxide. The loading of palladium on the support is preferably in the range from 5 to 10 wt. %.

The palladium catalyst can be used in the dry or wet state.

The ratio by weight of the catalyst used to 2-methyl-5-phenyl-2,4-pentadienal can be between 0.00001:1 and 0.01:1, a ratio of 0.0001:1 to 0.001:1 being preferred.

The hydrogen pressure during hydrogenation is advantageously 1 to 20 bar, preferably 1 to 5 bar.

The reaction temperature during hydrogenation is advantageously 20 to 100° C., preferably 50 to 80° C.

The reaction time for hydrogenation is advantageously 1 to 50 hours, preferably 6 to 15 hours.

The invention is illustrated in greater detail below by means of examples.

### EXAMPLES

1. Production of 2-methyl-5-phenyl pentanal by hydrogenation of 2-methyl-5-phenyl-2,4-pentadienal.

1794 g of 5-phenyl-2-methyl-2,4-pentadienal, produced according to the instructions given in DE 555490A, 360 g of 5% soda solution and 30 g of palladium on activated carbon 5% wet (40% water content) are placed in a stirred autoclave with a gas injection stirrer. The mixture is hydrogenated for 7.5 hours at 65° C under a hydrogen pressure of 5 bar. After filtration and separation of the soda solution, 1790 g of crude 2-methyl-5-phenyl pentanal are obtained (GC content 87%). Pure 2-methyl-5-phenyl pentanal (GC purity>98.5%) is obtained from this in a sensorially excellent quality by distillation over a 60 cm packed column under a vacuum of 1 mbar and at a boiling point of 80° C.

2. Production of a Perfume Oil Having a Modern, Pronounced, Floral Rose-Like Note.

The following fragrance substances are mixed together in the specified quantities (parts by weight):

| | |
|---|---|
| Ethyl acetoacetate | 13 |
| Hexenyl acetate, cis-3- | 1.5 |
| Vertocitral, Symrise | 1 |
| Hexenol, cis-3- | 0.5 |
| Isoananate, Symrise | 5 |
| Styrolyl acetate | 8 |
| Leguminal, Symrise | 0.2 |
| Dihydromyrcenol | 11 |
| Mandarin oil | 5 |
| Menthol l-, Symrise | 3 |
| Aldehyde C14 so-called | 1 |
| Lilal, Givaudan | 65 |
| Bourgeonal, Quest | 3 |
| Helional, IFF | 3 |
| Florhydral, Givaudan | 10 |
| Mugetanol, Symrise | 50 |
| Lyral ®, IFF | 57 |
| Ethyl linalool, Givaudan | 102 |
| Dimethylbenzylcarbinyl acetate | 3 |
| Phenyl ethyl alcohol | 20 |
| Geraniol | 10 |
| Citronellol | 18 |
| Citronellyl acetate | 7 |
| Geranyl acetate | 4 |
| Damascene alpha, Firmenich | 0.5 |
| Benzyl acetate | 14 |
| Methyl dihydrojasmonate | 158 |
| Hexenyl salicylate, cis-3- | 4 |
| Iraldein gamma, Symrise | 7 |
| Coumarin | 0.3 |
| Iso E Super, IFF | 18 |
| Patchouli oil | 4 |
| Sandolen, Symrise | 3 |
| Ambroxide cryst., Symrise | 1 |
| Globalide, Symrise | 18 |
| Ethylene brassylate | 21 |
| Total | 650 |

This starting composition is a perfume oil having a green, floral accord with a pronounced lily of the valley and rose note.

By adding 100 parts by weight of 2-methyl-5-phenyl pentanal to 650 parts by weight of the starting composition, a modern perfume having a pronounced original rose note is obtained. In comparison to the starting composition without 2-methyl-5-phenyl pentanal, the fragrance composition according to the invention containing 2-methyl-5-phenyl pentanal has a finer, more floral rose-like, more harmonious and rounder scent. The addition of 2-methyl-5-phenyl pentanal substantially increases the emanation and spatial effect of the starting composition.

1. A process for making a scented composition by adding 2-methyl-5-phenyl pentanal to said composition in an amount sufficient to produce, modify, or intensify a rose scent from said composition.

2. A process according to claim 1 in which a sufficient amount is added to modify the rose scent of a fragrance composition wherein said composition comprises at least one further fragrance substance having a rose scent.

3. A process according to claim 1 wherein a sufficient amount of 2-methyl-5-phenyl pentanal is added to produce a perfume having a rose scent.

4. Process for producing a perfume having a rose scent, with the following steps:
preparing 2-methyl-5-phenyl pentanal,
forming a fragrant perfume mixture comprising perfume constituents with an adequate amount of said 2-methyl-5-phenyl pentanal, such that the resulting perfume has a rose scent which is brought about or influenced by the presence of said 2-methyl-5-phenyl pentanal.

5. Process for producing, intensifying or modifying a rose scent in a composition, with the following steps:
preparing 2-methyl-5-phenyl pentanal,
mixing other constituents with an amount of said 2-methyl-5-phenyl pentanal which is sufficient (a) to bring about a rose scent in the resulting composition, (b) to intensify an existing rose scent in the composition comprising other constituents or (c) to modify an existing rose scent in the composition comprising other constituents.

6. Personal care product having a rose scent and comprising
2-methyl-5-phenyl pentanal.

7. Personal care product according to claim 6, chosen from the group comprising consisting of soaps, shampoos, bath additives, deodorants, skin creams and body lotions.

8. Fragrance mixture having a rose scent, comprising:
a sensorially effective amount of 2-methyl-5-phenyl pentanal, and
sensorially effective amounts of at least two further fragrance substances.

9. Fragrance mixture according to claim 8, wherein at least one of the further fragrance substances has a rose scent.

10. Perfumed product comprising a fragrance mixture according to claim 8 and a carrier or substrate which is in direct contact with the fragrance mixture.

11. Perfumed product according to claim 10, chosen from the group consisting of alcoholic perfumes, personal care products and cleaning or conditioning products for use in the home.

12. Perfumed product according to claim 11, wherein (a) the personal care product is chosen from the group consisting of soaps, shower gels, shampoos, bath additives, skin creams, body lotions and deodorants, and Ub the cleaning agent is chosen from the group consisting of detergents, fabric softeners, air fresheners and cleaners.

13. Process for producing 2-methyl-5-phenyl pentanal, characterised in that 5-phenyl-2-methyl-2,4-pentadienal is hydrogenated.
